(19) United States
(12) Patent Application Publication
(10) Pub. No.: US 2024/0370569 A1
(43) Pub. Date: Nov. 7, 2024

(54) SYSTEMS AND METHODS FOR MANAGING CYBERSECURITY RISK

(71) Applicant: Quant LLC, Richmond, VA (US)

(72) Inventors: Corey P. NESKEY, Arlington, VA (US); Robert A. NETTE, Richmond, VA (US); Thomas M. CARDMAN, Richmond, VA (US)

(21) Appl. No.: 18/311,569

(22) Filed: May 3, 2023

(51) Int. Cl. G06F 21/57; G06Q 10/0635

(52) U.S. Cl. CPC G06F 21/577; G06Q 10/0635; G06F 2221/034

(57) ABSTRACT

A cybersecurity risk management system includes a user-interface that receives input data associated with a risk scenario. The user-interface graphically displays the input data as an interactive probability distribution visually responsive to updated input data in real time to visualize monetary risk and direct strategic investments concerning risk mitigation controls.

### TECHNICAL FIELD

The application generally relates to systems and methods of managing cybersecurity risk, and more particularly, a cybersecurity risk management system including a novel user interface adapted to more intelligibly articulate cybersecurity risk for directing an organization's risk-mitigation investment strategy.

### BACKGROUND

As technology continues to evolve at a rapid pace, cyber events (e.g., system outages, data breaches, etc.) are a growing dilemma impacting the reputation and financial viability of organizations worldwide. Many organizations utilize risk assessment platforms to ascertain risk for implementing controls (e.g., antivirus software, firewalls, etc.) devised to prevent cyber events. However, existing risk assessment platforms fit awkwardly in the context of ongoing business operations because they rely on information that inaccurately reflects an organization's susceptibility to risk. This results in the implementation of security controls that fail to mitigate the financial loss associated with cyber events and/or cost considerably more than the financial loss they are intended to circumvent. Moreover, many risk assessment platforms utilize non-quantitative data (e.g., scorecards or words) to articulate cybersecurity risk. However, such data is problematic insofar as it can be interpreted differently between different people or even the same person at different times, resulting in poor decision-making regarding strategic investments. In addition, many risk assessment platforms fail to assess the efficacy of cybersecurity controls on an ongoing basis once an initial risk assessment is completed. Thus, it is desirable to have a cybersecurity risk management platform that more intelligibly articulates cybersecurity risk to improve strategic investments during an initial risk assessment and on an ongoing basis.

### SUMMARY

In accordance with a first aspect of the present invention, there is provided a cybersecurity risk management user-interface including one or more input components for receiving input data associated with at least one risk scenario. The user interface receives the input data, and the input data includes a loss value. The user-interface graphically displays the loss value as a first interactive probability distribution based on a first precision setting. The first interactive probability distribution is visually responsive to changes in the loss value and/or the first precision setting in real time to visualize monetary risk.

In accordance with a second aspect of the present invention, there is provided a cybersecurity risk management system including a risk-modeling component that receives scenario data. The scenario data includes at least one of an agent, intent, state, valuable, and surface. The risk-modeling component recommends a risk mitigation control based on the scenario data.

In accordance with a third aspect of the present invention, a method of managing cybersecurity risk includes providing a cybersecurity risk management system including a risk-modeling component and a user-interface, and receiving scenario data and loss data concerning a cybersecurity risk scenario, wherein the user-interface visualizes the loss data in the form of a first interactive quantile-dot plot. The method also includes determining a first expected monetary loss, receiving control data, and receiving updated loss data, wherein the user-interface visualizes the updated loss data in the form of a second interactive quantile-dot plot. In addition, the method includes determining, via the risk-modeling component, a second expected monetary loss based on the updated loss data.

Any one of the above aspects (or examples of those aspects) may be provided alone or in combination with any one or more of the examples of that aspect discussed above; e.g., the first aspect may be provided alone or in combination with any one or more of the examples of the first aspect discussed above; and the second aspect may be provided alone or in combination with any one or more of the examples of the second aspect discussed above; and so-forth.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary and are intended to provide an overview or framework to understanding the nature and character of the claims. The accompanying drawings are included to provide a further understanding and are incorporated in and constitute a part of this specification. The drawings illustrate one or more embodiments, and together with the description serve to explain principles and operations of the various embodiments.

### BRIEF DESCRIPTION OF THE DRAWINGS

The above and other features, examples and advantages of aspects or examples of the present disclosure are better understood when the following detailed description is read with reference to the accompanying drawings, in which:

FIG. 1 illustrates a block diagram of a cybersecurity risk management system according to an embodiment;

FIG. 2 illustrates another block diagram of an exemplary cybersecurity risk management system according to another embodiment;

FIG. 3 is a representation of an exemplary user interface for entering project costs for a cybersecurity risk assessment;

FIG. 4 is a representation of an exemplary user interface for entering project benefits for a cybersecurity risk assessment;

FIG. 5 is a representation of an exemplary user interface for adding assets associated with a cybersecurity risk assessment;

FIG. 6 is a representation of an exemplary user interface for creating risk scenarios for a cybersecurity risk assessment;

FIG. 7 is a representation of an exemplary user interface for entering loss magnitude for a cybersecurity risk assessment;

FIGS. 8A-8C are representations of an exemplary user interface for modeling expected loss via an interactive quantile-dot plot;

FIG. 9 is a representation of an exemplary user interface for entering loss event frequency data and modeling the loss event frequency data via an interactive quantile-dot plot;

FIG. 10 is a representation of an exemplary user interface for entering loss values for multiple risk scenarios selected simultaneously;

FIG. 11 is a representation of an exemplary user interface for entering cost estimates for a cybersecurity risk assessment and modeling the cost estimates via an interactive quantile-dot plot;

FIG. 12 is a representation of an exemplary user interface for mapping controls to scenario data for a cybersecurity risk assessment;

FIG. 13 is a representation of a list of recommended controls (in the form of a popup) generated based on scenario data;

FIG. 14 is a representation of an exemplary user interface for creating control plans for a cybersecurity risk assessment;

FIGS. 15A, 15B, and 16 are representations of exemplary reports associated with a cybersecurity risk assessment;

FIG. 17 is a representation of another exemplary report associated with a cybersecurity risk assessment;

FIGS. 18A and 18B are representations of an exemplary user interface for a risk management trajectory board; and

FIG. 19 is a flow chart illustrating an exemplary methodology of managing cybersecurity risk; and

### DETAILED DESCRIPTION

The following includes definitions of exemplary terms used throughout the disclosure. Both singular and plural forms of all terms fall within each meaning:

The terms “component” and “system,” as used herein, are intended to refer to a computer-related entity, either hardware, a combination of hardware and software, software, or software in execution. For example, a component may be, but is not limited to being, a process running on a processor, a processor, an object, an executable, a thread of execution, a program, and a computer. By way of illustration, both an application running on a server and the server can be a component. One or more components may reside within another component and/or be localized on one computer and/or distributed between two or more computers. In some embodiments, each component may comprise software specific to that component. In some embodiments, multiple components may be embodied by one software, e.g., a standalone program for all components.

The term “software,” as used herein, is intended to refer to computer readable and/or executable instructions that cause a computer, logic, or other electronic device to perform functions, actions, and/or behave in a desired manner. The instructions may be embodied in various forms such as routines, algorithms, modules or programs including separate applications or code from dynamically linked libraries. Software may also be implemented in various forms such as a stand-alone program, a function call, a servlet, an applet, instructions stored in a memory, part of an operating system or other type of executable instructions. Il will be appreciated by one of ordinary skill in the art that the form of software is dependent on, for example, requirements of a desired application, the environment it runs on, and/or the desires of a designer/programmer or the like.

The term “server,” as used herein, is intended to refer to a computerized component, system or entity regardless of form adapted to provide data, files, applications, content, or other services to one or more other devices or entities on a computer or other network.

The term “agent,” as used herein, is intended to refer to an actor, an entity, an organization, an association, or media responsible for a cyber-attack, including, but not limited to, a hacker, a system administrator, an IT professional, a corporate executive, a salesperson, malware, a virus, ransomware, and the like.

The terms “surface” and “asset” as used herein, are intended to refer to any item or feature that helps an organization perform work, and that can be exploited by an agent, including, but not limited to, a computer, a server, a webpage, software, data, emails, desktops, laptops, network equipment, servers, and the like.

The term “valuable,” as used herein, is intended to refer to anything sought by the “agent,” including, but not limited to, proprietary information, non-public/confidential data, personal identifiable information, currency, stocks, cryptocurrency, and the like.

The term “state,” as used herein, is intended to refer to the impact of a cyber event, for example, a breach of confidential data, data corruption (e.g., an event impacting the integrity of the data), and the like.

Embodiments of systems, architectures, processes, and methods for ascertaining and managing cybersecurity risk are disclosed herein. The examples and figures herein are illustrative only and are not meant to limit the subject invention, which is measured by the scope and spirit of the claims. The showings are for the purpose of illustrating exemplary embodiments of the subject invention only and not for the purpose of limiting same.

As described below in connection with the figures, a cybersecurity risk management system is provided that utilizes unique user interfaces for visualizing information associated with one or more risk scenarios. The user interface(s) includes various input components for receiving input data corresponding to project costs and benefits, assets of the organization, risk scenario data, loss values, loss event frequency values, updated loss values, confidence/precision settings, quantile settings, and risk-mitigation controls and their corresponding costs. The user interface graphically visualizes estimated project costs and benefits, and estimated losses due to one or more risk scenarios in a dynamic, interactive manner as input data is updated. For example, as input data is modified, the corresponding output, which is graphically displayed as a probability distribution, changes in real-time as well. A change in the probability distribution displayed to the user can result from a change in any of input components such as, but not limited to project cost data fields, project benefits data fields, loss value data fields, loss event frequency data fields, controls cost data fields, and the like.

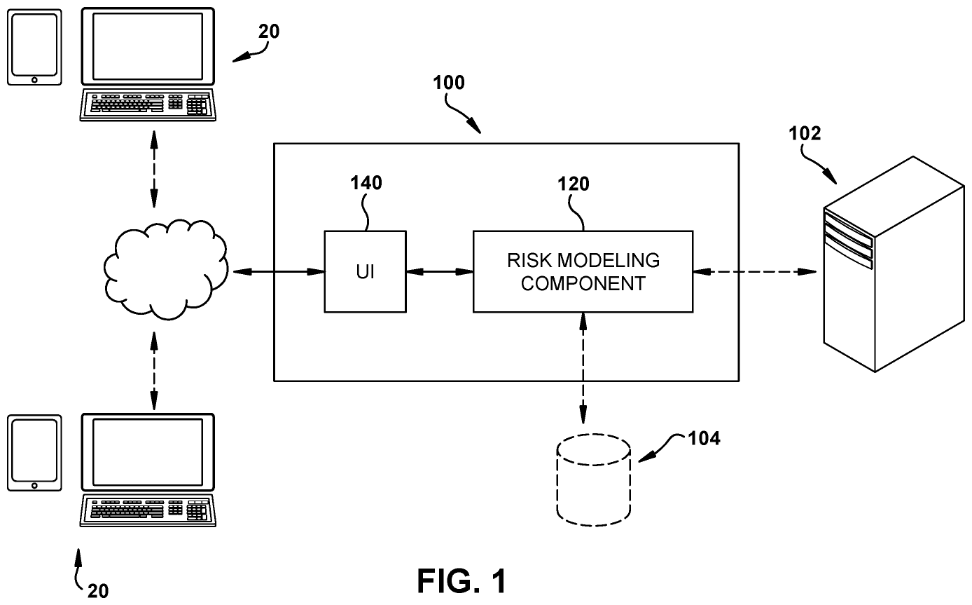

Turning to FIG. 1, a block diagram of an exemplary cybersecurity risk management system 100 is shown. The various examples of cybersecurity systems and methodologies described herein help organizations make better investment decisions concerning risk mitigation controls under conditions of uncertainty regarding an organization's susceptibility to high-impact cyber events. Unlike conventional risk modeling solutions, the cybersecurity risk management system 100 allows users to express their uncertainty concerning estimates (i.e., project costs, project benefits, monetary expected losses, control costs, etc.) resulting in a more accurate portrayal of risk.

In general, the cybersecurity risk management system 100 includes a risk modeling component 120 and a graphical user-interface 140 that allows users to interact with the risk modeling component 120. The user-interface 140 may comprise one or more input components corresponding to various types of data including but not limited to project cost data, project benefit data, asset data, scenario data, loss value data, loss event frequency data, controls data, confidence/precision data, and quantile data. The cybersecurity risk management system 100 may reside on a remote server 102 and be made available as a software-as-a-service to users of the risk modeling component 120. For example, users may access the cybersecurity risk management system 100 via user devices 20 (e.g., smartphones, tablets, laptops, and the like) by accessing a login page and entering a username and password, or via outsourced authentication, e.g., log in with Google®.

The cybersecurity risk management system 100 may also reside on a form of memory 104, including, but not limited to, a local or remote memory storage device, a remote database, a local database, a cloud-computing platform, a cloud database, or a combination thereof. In some embodiments, the cybersecurity risk management system 100 may be provided as a form of computer-readable media, for example, but not limited to, volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other magnetic storage devices, or any other medium which can be used to store the desired information and which can be accessed by the user. In addition, the cybersecurity risk management system 100 may be operatively connected to a domain knowledge component 285, an industry data component 290, and an internal data component 295, as discussed in detail below.

The risk modeling component 120 guides users through interactive risk models devised to support investment decision making (i.e., concerning security resource allocation) under conditions of uncertainty regarding high-impact cyber events. In this manner, the risk-modeling component 120 receives inputs from the user (entered via the user-interface 140) and outputs information (via the user-interface 140) at each stage of a risk management methodology as discussed below. The risk-modeling component 120 can also receive information transmitted or electronically communicated from other desired sources such as internal or external databases. The output information is dynamic in that the user can fine tune the output information (e.g., project costs, project benefits, monetary loss values, and the like) based on a desired or selected confidence/precision level.

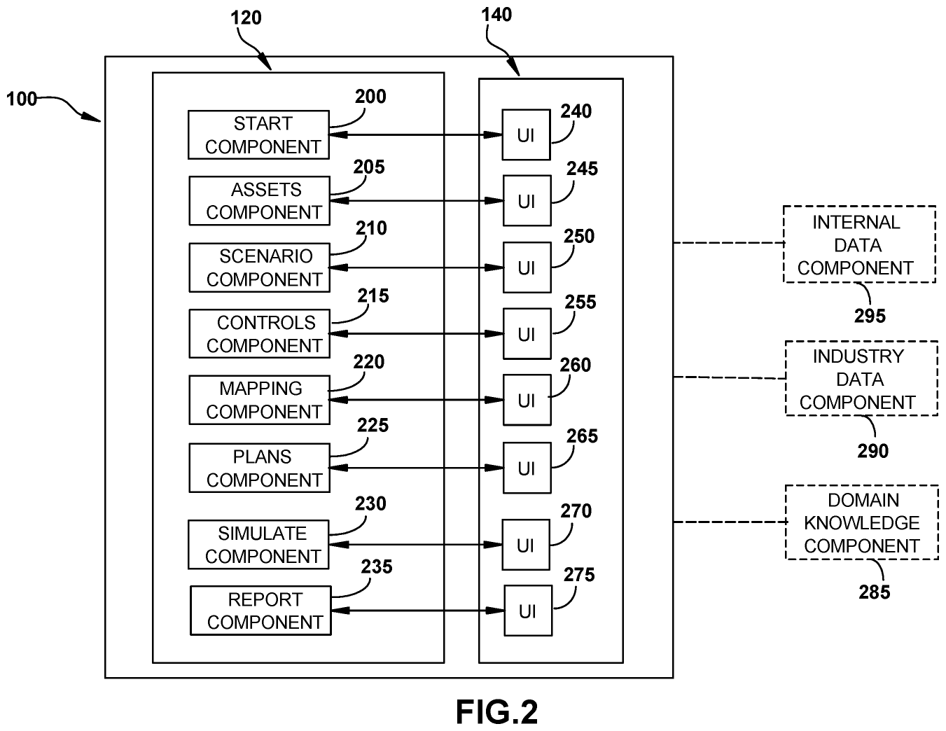

In FIG. 2, the risk-modeling component 120 may include a plurality of sub-components, including, some or all of the following: a start component 200, an assets component 205, a scenario component 210, a controls component 215, a mapping component 220, a plans component 225, an assess or simulate component 230, and a report component 235.

The start component 200 receives input data concerning project costs and benefits associated with a cybersecurity risk assessment or project (e.g., implementing a new email product, a support package, an outsourced service, and the like.). For example, projects costs may include but are not limited to labor costs, outsourced costs, initial and ongoing expenses for a product or service associated with the cybersecurity project or risk assessment. Project benefits may include but are not limited to monetary gains or cost savings derived from carrying out the cybersecurity risk assessment or project, e.g., labor reduction hours, operating cost reduction, and the like.

The assets component 205 receives input data corresponding to any item or feature (e.g., tangible, or intangible) used by the organization to perform work. Examples of assets include but are not limited to servers, laptops, desktops, handhelds, network equipment, software, and the like.

The scenario component 210 receives input data regarding one or more risk scenarios modeled by the user, including, but not limited to, scenario data (i.e., the agent responsible for a risk event, the agent's intent, the impact of the event on data or assets of the organization, the valuable sought by the agent, the surface exploited by the agent to obtain the valuable), and loss data associated with a scenario (i.e., monetary expected loss magnitudes or values, loss event frequency data, and the like). The scenario component 210 also projects a visual distribution to the user based on input data it receives, as discussed in detail below.

The controls component 215 receives input data concerning any mitigation controls and associated costs (i.e., control data) under consideration by the user to circumvent risk. The controls component 215 also projects a visual distribution to the user based on control data it receives, as discussed in detail below.

The mapping component 220 maps control data to scenario data for assessing the monetary impact of controls (e.g., expected monetary losses). The mapping component 220 also recommends controls based on scenario data it receives. The plans component 225 devises plans, with each plan comprising one or more controls based on input data it receives, e.g., proposals submitted by the user. The simulate component 230 projects the efficacy (e.g., expected monetary loss) of each plan relative to another via a plurality of simulations (e.g., Monte Carlo simulation, a Markov Chain Monte Carlo simulation, and Bayesian networks). The report component 235 utilizes the plurality of simulations to project the expected monetary loss or expected net value associated with each plan to inform the user as to the projected efficacy of each plan.

Each of the sub-components may be accessed by the user via the user interface 140. In this manner, each sub-component receives user input data that may be stored by the cybersecurity risk management system 100, for example, on a remote server 102 (FIG. 1) or memory 104 (FIG. 1), for example, a local or remote memory storage device, a remote database, a local database, a cloud computing platform, a cloud database, or a combination thereof. In the illustrated example, each sub-component may perform their respective operations and analyses based on user input data entered via the user-interface 140, whereupon the results of such analyses are graphically illustrated via the user-interface 140.

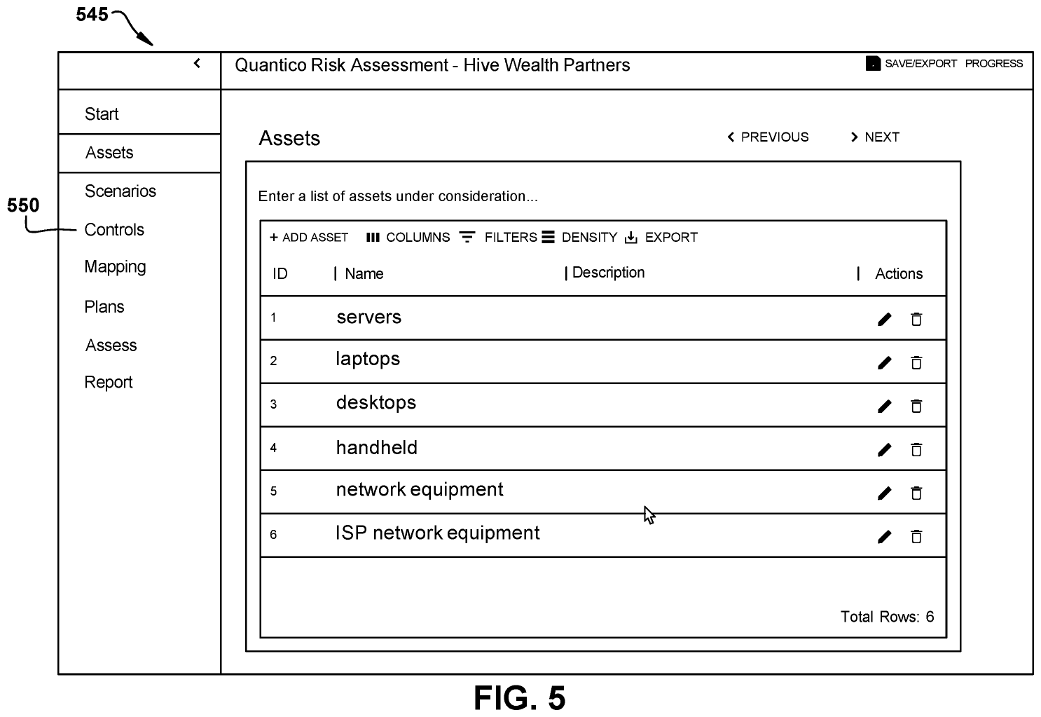

Moreover, each sub-component may comprise a corresponding user-interface, for example, a start user-interface 240, an assets user-interface 245, a scenario user-interface 250, a controls user-interface 255, a mapping user-interface 260, a plans user-interface 265, a simulate user-interface 270, and a report user-interface 275. In the illustrated embodiment, each user interface 240-275 forms a part of the user-interface 140. The user-interfaces 240-275 display their respective data which then can be used in further analyses to facilitate understanding and assessing risk in a visual and interactive manner. It is contemplated that each user-interface may embody an independent user-interface. In addition, each user-interface may include a static side bar (see, e.g., 550 in FIG. 5) operable to select or otherwise navigate between the subcomponents 200-235 of the risk-modeling component 120.

As noted above, the cybersecurity risk-management system 100 (i.e., the risk modeling component 120 and/or the user-interface 140) may be operatively connected to a domain knowledge component 285, an industry data component 290, and an internal data component 295. The domain knowledge component 285 is operable to elicit and/or receive estimates from experts in the field concerning input data (e.g., project cost/benefit, loss value, loss event frequency, control costs) for a risk assessment (i.e., a risk model) under consideration. These estimates may be transmitted to the corresponding input components of the user-interfaces to inform the risk assessment, e.g., project cost/benefit data fields, loss value data fields, loss event frequency data fields, control cost data fields, and the like.

The industry data component 290 is operable to receive the input data based on industry data in the marketplace, including, but not limited to, public data sources. The internal data component 295 is operable to receive input data derived from internal data of the subject organization, person, or entity carrying out the risk assessment or project. The internal and industry data derived from the industry data component 290 and internal data component 295 may be transmitted to the corresponding input components of the user-interface to inform the risk assessment.

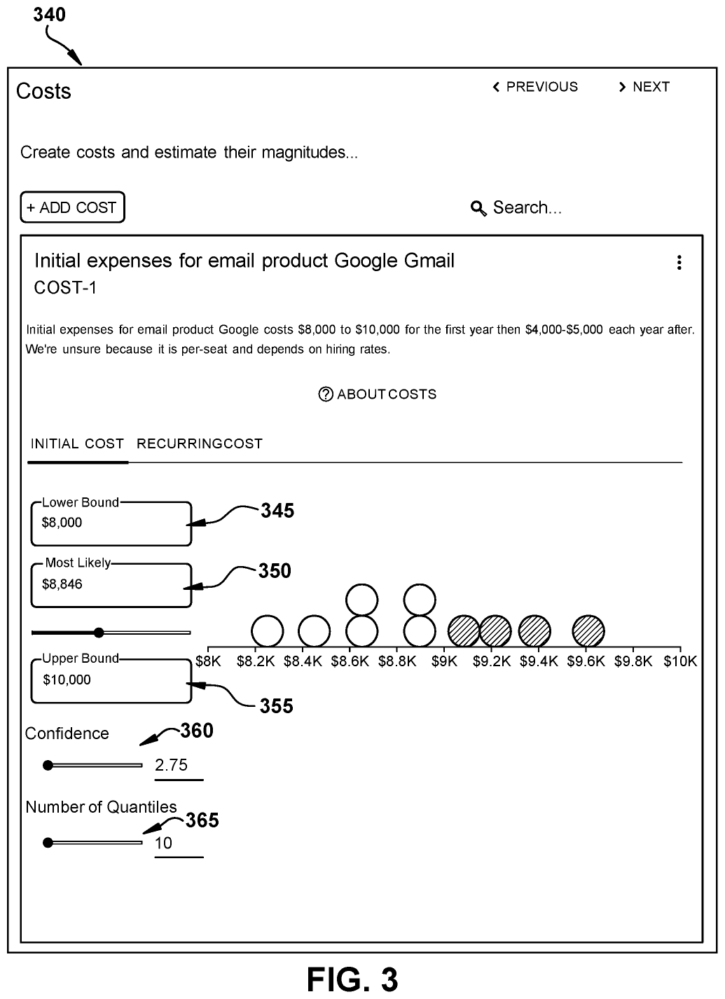

FIG. 3 illustrates an example start user-interface 340 that includes input components for receiving inputs concerning project costs associated with the cybersecurity risk assessment or project under consideration. The project costs may take the form of initial costs and/or recurring costs. For instance, the project costs may include but are not limited to labor costs, outsourced costs, initial and ongoing expenses for a product or service, and the like. The project costs may be entered as a range comprising three values, including a lower bound value, an upper bound value, and a most likely value, wherein all three values form part of a probability distribution (e.g., a Beta distribution) reflected in an interactive quantile dot plot, as discussed in detail below. The project costs may be derived from vendor proposals or from other sources, including, but not limited to, expert estimates, industry data, and internal data, for example, using any of the examples of knowledge or data elicitation discussed above.

In the illustrated example, the start-user interface 340 includes input components 345, 350, 355 (project cost data fields) for receiving a lower bound, an upper bound, and a most likely project cost value, respectively. In addition, it includes a confidence or precision slider input component 360 operable to adjust the confidence or precision level desired, and a quantile slider input component 365 operable to increase or decrease the number of quantiles used to depict the corresponding quantile dot plot.

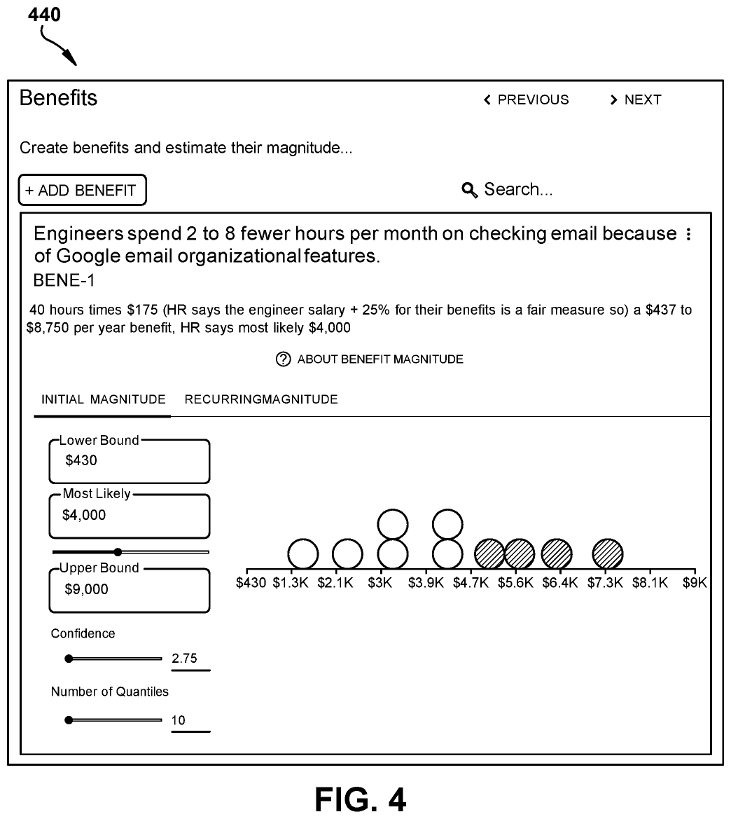

Turning to FIG. 4, an example illustration of another start-user interface 440 is shown including input components for receiving inputs concerning project benefits derived from the cybersecurity project risk assessment or project under consideration. For example, project benefits may include monetary gains or cost savings associated with the cybersecurity risk assessment or project and may take the form of initial and/or recurring monetary benefits. As can be seen, the start-user interface 440 has several of the same features as the start-user interface 340 discussed above. For example, the user may enter project benefit values as a range comprising a lower bound, an upper bound, and a most likely value to result in a distribution reflected in an interactive quantile dot plot, as discussed in detail below. Moreover, the project benefit values may similarly be derived from expert, industry, or internal data using any of the examples of knowledge or data elicitation discussed above.

In some embodiments, the start-user interface 240, 340, 440 may include one or more data fields for receiving user information, for example, the user's name and the name of the user's organization. In some embodiments, the start user-interface 240, 340, 440 as described herein may be operable to grant access to other users of the cybersecurity risk management system, including, but not limited to, subject matter experts in the field, the user's peers, colleagues, and the like. In such embodiments, the user information may be stored by a remote server 102 (FIG. 1) or external memory 104 (FIG. 1).

FIG. 5 illustrates an example assets user-interface 545 that includes input components for entering asset data. Other input components may be provided as shown to facilitate modifying the asset data, customizing the view of the data and/or exporting the data for use in other applications or otherwise sharing it. The assets user-interface 245, 545 as described herein is configured to receive information from the user concerning any assets associated with cybersecurity risk scenarios modeled by the user, for example, servers, laptops, handhelds, and the like. Specifically, the assets user-interface 245, 545 includes data fields or other input components (e.g., pre-populated list of items with selection tool) for a user to add and/or delete assets to the risk modeling component 120 (FIG. 2). In such embodiments, each asset may be designated with a unique identifier (e.g., a number as shown). As can be seen, the assets user-interface 245, 545 may embody a tabular user interface with rows, columns, and conditional filtering capabilities.

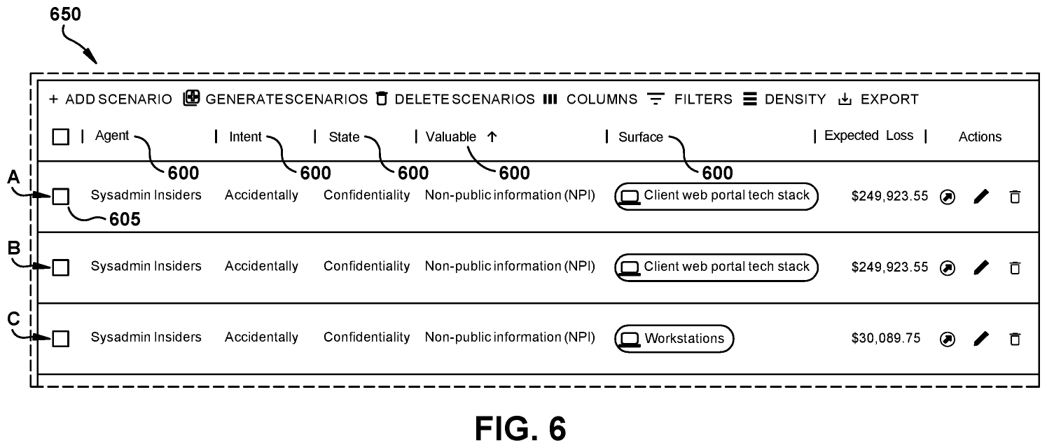

Turning to FIG. 6, an example scenario user-interface 650 is shown that displays risk scenarios (e.g., A, B, and C) each associated with scenario data 600 unique to the respective risk scenario. The scenario data 600 relates to each risk scenario that the user desires to model, including, but not limited to, the actor or agent (e.g., a system administrator, a hacker, malware, etc.) responsible for the risk event, the agent's intent (e.g., deliberate, accidental), the impact on the state of organizational data or assets (e.g., the loss of confidentiality, integrity, or availability of data or assets), the valuable sought by the agent (e.g., currency, proprietary data, personal identifiable information, patient health records, etc.) and/or the surface exploited by the agent to obtain the valuable, for example, a corporate laptop, email inboxes, a server, a desktop, etc.

An example scenario based on scenario data may include a system administrator (agent) who accidentally (intent) exposed health records (loss of confidentiality-which defines the state) to the internet via a server (surface). Another scenario may include malware (agent) that deliberately infected (intent) the availability (state) of patient data (valuable) through a server (surface). In some embodiments, the user may generate a data flow diagram to contemplate the scenario data based on risk scenarios contemplated by the user. In such embodiments, the risk-modeling component 120 may utilize a data flow diagrammer (not shown), enabling the user to contemplate scenario data by mapping data flows between sensitive data and critical systems.

With reference to FIG. 6, the scenario user-interface 250, 650 may embody a tabular user-interface including rows, each associated with a risk scenario, and columns, each associated with a specific form of scenario data 600 (i.e., agent, intent, state, valuable, surface, and expected loss (discussed above)). In addition, the scenario user-interface 250, 650 may include a check box 605 for selecting one or more risk scenarios to be evaluated. In some embodiments, the scenario user-interface 250, 650 may warn users if information is missing from any of the scenarios (e.g., via a popup message), prompting the user to assess whether they should include the missing information. For instance, scenario data excluded from a risk scenario may be noted in a final report and saved by the cybersecurity risk management system (e.g., via the server 102 (FIG. 1) or memory 104 (FIG, 1) such that the subject organization does not lose track of them (thereby creating a blind spot in the risk model).

The scenario user-interface 250, 650 as described herein can also receive inputs from the user concerning the expected monetary loss (i.e., magnitude of exposure) associated with one or more risk scenarios. For the purposes of the present disclosure, the expected monetary loss will be referred to as a “loss value.” In one example, the user may enter the loss value as a range comprised of three values such as a lower bound value, an upper bound value, and a most likely value, wherein all three values form part of a probability distribution (e.g., a Beta distribution). Preferably, loss values are derived from experts in the field, for example, advisors, consultants, senior analysts, or subject matter experts familiar with the particular risk scenario at issue. For example, the loss value may be derived from an expert's opinion as to the minimum, maximum, and most likely loss dollar amounts associated with the risk scenario at issue and be presented as an estimate by the expert.

For this purpose, the domain knowledge component 285 (FIG. 2) may be used to elicit estimates (e.g., loss values, loss event frequencies) directly from experts in the field for informing a risk model. In one example, the user may use the domain knowledge component 285 to submit estimate requests for receiving expert feedback directly via an email or app message containing a survey (e.g., with questions based on the risk-scenario at issue). In such embodiments, the user request may include scenario data such as the type of cyber event, the subject organization (#of employees, industry segment), the agent, the intent, the state, the valuable, the surface, and/or any other information associated with the risk scenario at issue. In some embodiments, the user may grant the expert access to the user-interface 650 (FIG. 6) such that the expert can enter the loss value and/or loss event frequency estimates directly into a risk model via the domain knowledge component 285.

(0062) Moreover, loss values and/or loss event frequency data may be elicited from several experts in the field, each independently surveyed concerning the risk scenario at issue, for example, via crowd elicitation methods such as Delphi and IDEA method variations from peer reviewed research. Advantageously, obtaining loss values and/or loss event frequency data via expert estimates in this manner precludes group bias, thereby improving the quality of the input data. In such embodiments, loss values may be determined as an average of multiple loss values. For example, the lower bound loss value may be an average of five lower bound loss values obtained from five experts in the field (e.g., each independently surveyed). Moreover, each expert prompted for feedback may receive access to a user-interface, for example, the user-interface 650 of FIG. 6 for entering loss values.

In other embodiments, the loss values and/or loss event frequency data may be derived from industry data in the marketplace. For this purpose, the industry data component 290 (FIG. 2) may send loss data (i.e., loss values, loss event frequency data) to the risk-modeling component 120 (FIG. 2) based on the risk scenario at issue (e.g., to populate the scenario user-interface). For example, the industry data component 290 may be operatively connected to public data sources (e.g., sources such as VERIS or Advisen) comprising loss data organized by industry demographics (e.g., industry segment, size, and the like). In some embodiments, the risk-modeling component 120 (FIG. 2) may accept live telemetry from the industry data component 290, for example, from automated sources such as CMS, vulnerability management, and SIEM databases.

Yet, in other embodiments, the internal data component 295 (FIG. 2) may be utilized to send loss values and/or loss event frequency data to the risk modeling component 120. In such embodiments, the user may discover that the internal data component 295 has loss values associated with the risk scenario at issue, for example, based on previous (real) data breaches impacting the user's organization. The loss values and/or loss event frequency data can also be derived from internal data of the organization that are retrieved from an operating system of the organization. In this instance, the operating system is operatively connected to the internal data component to transmit and communicate data therebetween.

In such embodiments wherein expert data, industry data, or internal data is used to inform the risk-modeling component 120, the user may refine the loss values and/or loss event frequency data in a manner that is reflective of the user's organization profile (accounting for nuances distinct to the user's organization and/or the current state of the organization). In some embodiments, the risk-modeling component 120 may prompt a user (e.g., via a popup message) to provide rationale for any deviation from a reference value, e.g., any deviation from expert, industry, or internal loss data. Because the risk-modeling component 120 is configured to receive loss values and/or loss event frequency data from various sources, the risk-modeling component 120 is particularly advantageous for instilling confidence in the user (e.g., as a confidence check relying on industry or expert loss value and loss event frequency estimates). Yet, in some embodiments, the user may discover that collecting loss values and/or loss event frequency data from other sources may not be worth the expenditure and effort, for example, if the cost of acquiring and/or processing such data outweighs the value of retrieving it. For instance, if a user's estimated range of loss values is narrow enough to make a decision, then the cost of acquiring expert estimates might outweigh the value derived from those estimates, e.g., wherein the expert estimates would only narrow the range trivially. Another reason that a user may forgo retrieving data from other sources is that such data may not be sufficiently representative of their organization.

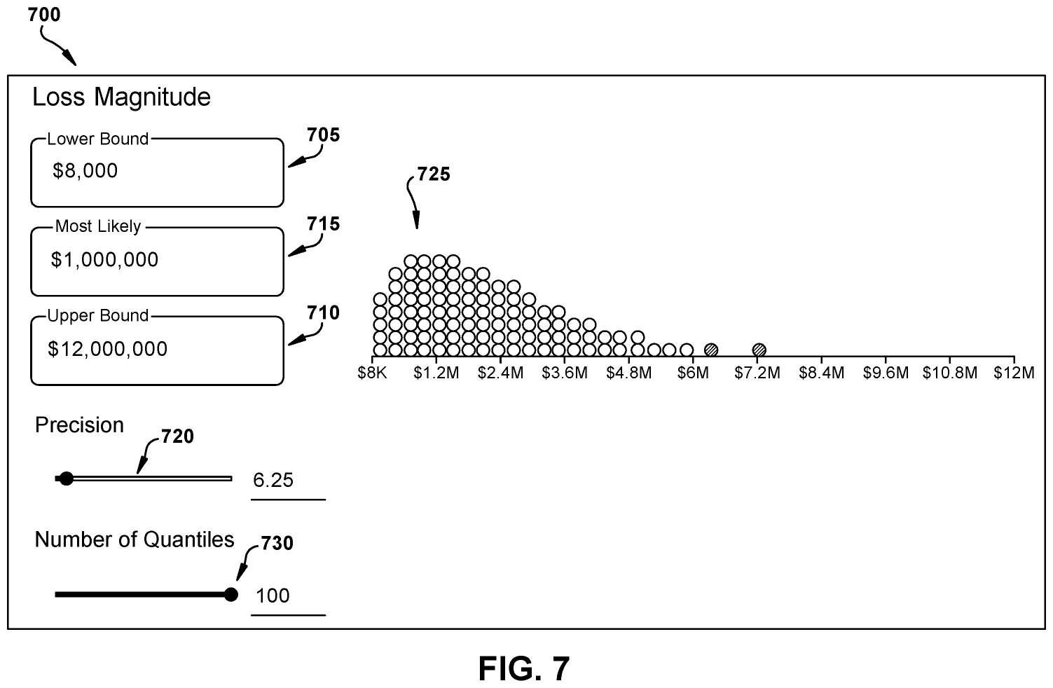

With reference to FIG. 7, an example scenario user-interface 700 is shown which displays a “loss magnitude” distribution as determined by the loss data and desired number of quantiles and confidence or precision. As discussed above, the loss value is represented as a range comprised of a lower bound 705, an upper bound 710 and a most likely value 715 (loss data fields). The user-interface 700 also includes a confidence or precision slider input component 720 which the user can adjust from lower to higher values corresponding to the confidence or precision level desired. When loss data are entered in the loss data fields 705, 710, 715 and a first confidence level is selected via the precision slider input component 720, a resulting first probability distribution 725 is displayed preferably as an interactive quantile dot plot 725, wherein each quantile or dot corresponds to a possible outcome (e.g., a possible loss amount $ associated with the selected risk scenario).

To further customize the interactive quantile dot plot 725, a quantile slider input component 730 is also included in the user-interface 700. If more quantiles are desired, then the user can slide the quantile slider input component 730 to increase the number of quantiles used to represent the plot 725. If less quantiles are preferred, then the quantile slider input component 730 can be moved by the user accordingly and the dots will enlarge in size to maintain the overall shape of the distribution 725. The quantile slider input component 730 allows the user to customize the view of the probability distribution but does not alter the probability distribution.

Unlike conventional practices in this field, the present user interface 700 provides an interactive visualization tool that illustrates possible monetary losses in a dynamic and fluid manner as the user changes the parameters (loss data fields, confidence). As the user edits the data and slides the confidence/precision slider input component 720, the probability distribution visually changes in real time. This allows the user to readily understand the monetary effect as the confidence level fluctuates (by the user sliding the precision slider input component 720) and as the loss data either remains fixed or is also changed.

The user-interface 700 is adapted to visualize the loss values in the form of ranges and distributions instead of single-value numbers. Input data including loss values, precision or confidence can be updated and upon receipt of updated input data, loss values resulting from the updated input data can be quickly displayed to the user through the use of quantile dot plots. The authors of the present disclosure have discovered that visualizing input data (e.g., project costs, project benefits, control costs, loss values, loss event frequency, and the like) in the form of ranges and distributions, and particularly in the form of quantile-dot plots, provides a more practical and more expansive frame of reference of outcome data points which stimulates the minds of the intended audience (e.g., business executives, CIOs, etc.) more effectively in contrast to conventional risk models. This results in more accurate models of an organization's susceptibility to risk.

Contrary to traditional approaches, the user-interface 700 is configured to allow the user to express their confidence in the loss values by shaping the probability distribution in real time. As defined herein, “real time” is intended to mean that the user-interface 700 of the present disclosure receives and displays changes based on user inputs in real time or near real time, for example, within about 0.1-3 seconds of real time.

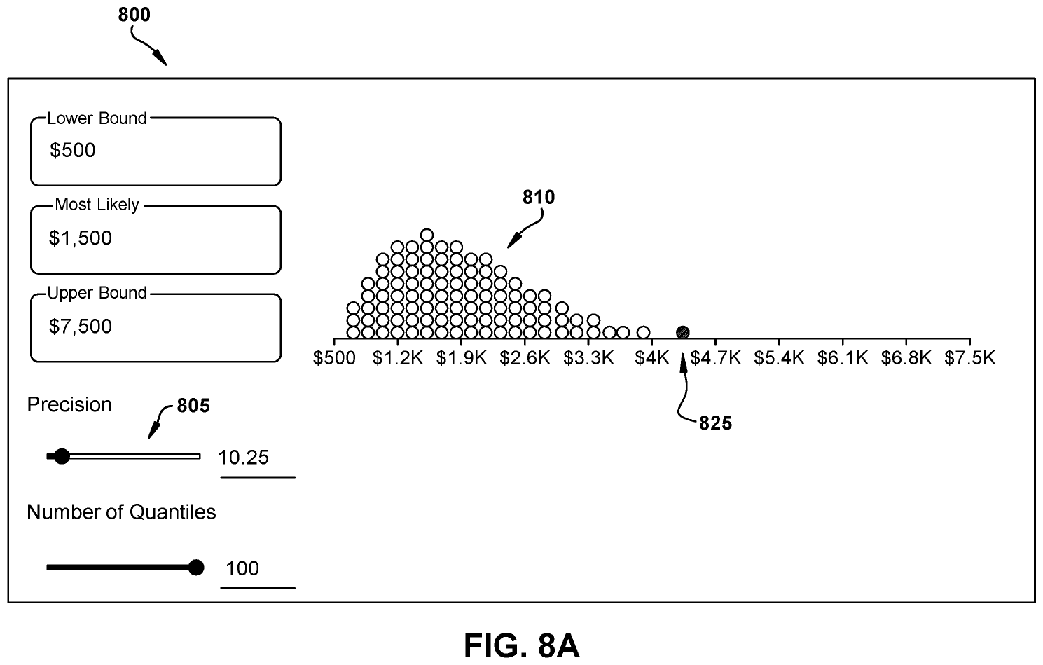

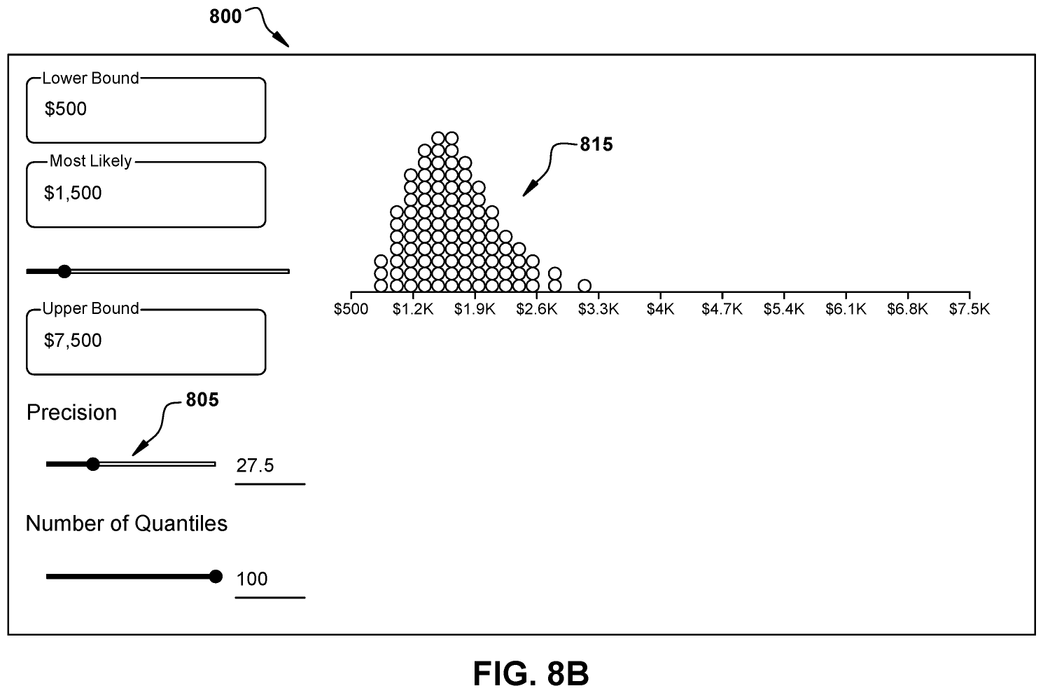

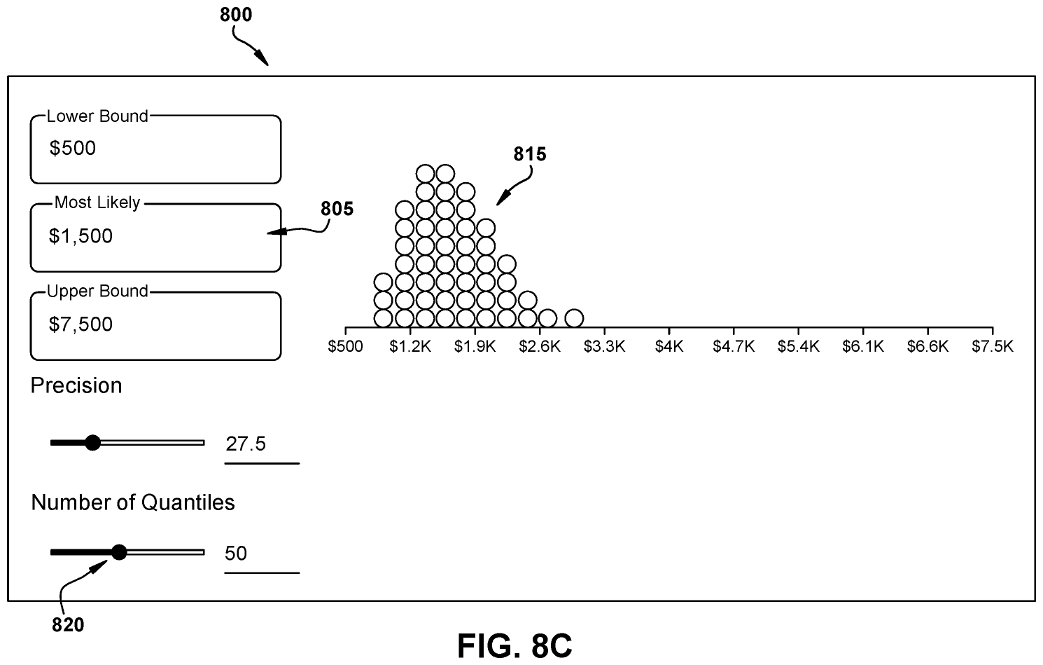

FIGS. 8A and 8B illustrate the interactive aspects of the user-interface 800 due in part to a confidence or precision slider input component 805. FIG. 8A shows the precision slider input component 805 set at 10.25 which yields a first probability distribution. The first probability distribution is visualized based on a selected first confidence or precision level. As can been seen, the first probability distribution is relatively wide. As the precision slider input component 805 is moved to increase the precision to 27.5 in FIG. 8B, a second or subsequent confidence or precision input can be selected. For instance, when moving the precision slider input component 805 to the right, the probability distribution 810 dynamically changes to result in a narrower distribution of values 815 (resulting in a higher concentration of values near the most-likely value). The wider distribution of values 810 in FIG. 8A reflects that there is a lower concentration of values surrounding the most-likely value due to the lower confidence or precision. The user can change the loss values to observe how hypothetical changes impact the model of monetary loss in real time. For example, the user may observe the probability distribution and find that a most likely value of $2,000,000 may be more appropriate upon studying the shape of the distribution (e.g., relative to the mean value).

As discussed earlier, the user interface 800 may be operable to increase or decrease the number of quantiles (i.e., dots) by adjusting a quantiles slider input component 820, giving the resulting distribution a different appearance. As the quantiles slider input component 820 is moved to decrease the number of quantiles from 100 to 50 in FIG. 8C, such as by moving the quantiles slider input component 820 to the left, the size of each quantile or dot increases, giving the resulting distribution a different appearance. In this manner, the quantiles slider input component 820 can change the appearance of the distribution via the number of quantiles or dots selected. For example, some users may prefer a higher quantity of quantiles to give the resulting distribution a more refined and smoother appearance (e.g., based on user preference).

In such embodiments, the user interface may also depict a quantile or dot 825 (FIG. 8A) that is shaded or colored differently or otherwise visually modified and that corresponds to a mean value between the lower bound and upper bound values. The visually modified dot may serve as a reference to assess the user's confidence in the distribution, e.g., as a goalpost or confidence check in the estimated values provided.

As described herein, visualizing input data (e.g., project data, including project costs and monetary benefits (discussed above), loss data, including loss values and loss event frequency data, or control data, including control cost values (discussed below)) in the form of an interactive quantile-dot plot allows the input data to be stimulated more accurately and predictably in the minds of the intended audience, thereby increasing the user's confidence in the resulting model, and providing for a more accurate portrayal of risk under conditions of uncertainty. Accordingly, by obtaining a more accurate portrayal of risk, the user's organization is better positioned to make more accurate strategic investment decisions concerning security measures (e.g., control plans) to circumvent cyber risk.

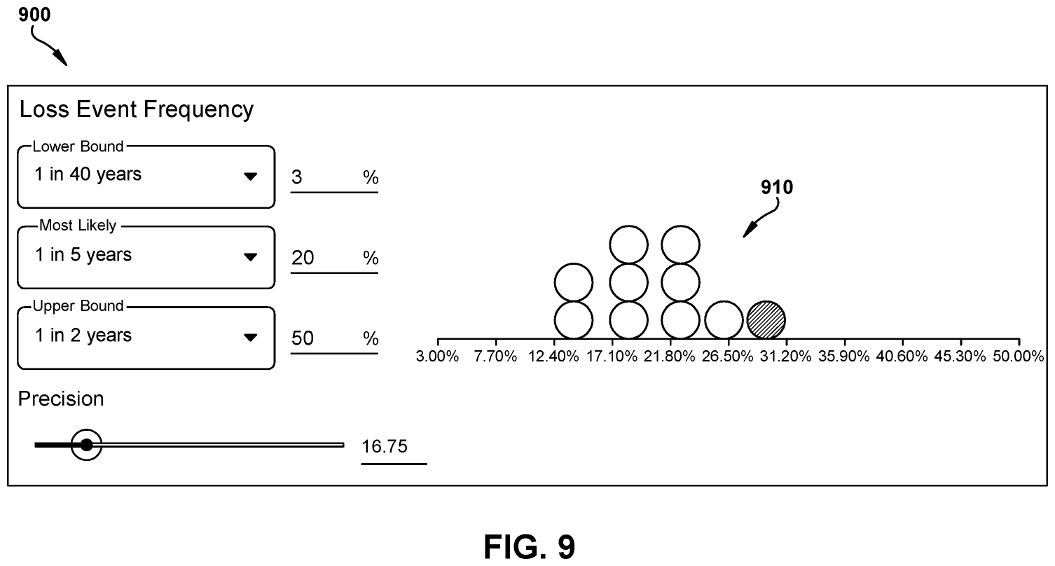

Referring to FIG. 9, the scenario user-interface 250, 700, 800 as described above may also be useful to visualize loss event frequency. A user-interface 900 for loss event frequency is similar as previously described. The user-interface 900 is operable for data entry and display of outcome information concerning loss event frequency. Loss event frequency data is a variable depicting the expected probability of a cyber event materializing (as a percentage) based on a time frame. Like loss values, the loss event frequency data may be entered as a range comprising three values, i.e., a lower bound, an upper bound, and most likely value. Similarly, the loss event frequency data may be derived from expert feedback, industry data, or internal data, for example, via any such example of knowledge or data elicitation described above, e.g., the domain knowledge component 285, the industry data component 290, and the internal data component 295, etc. The loss event frequency data distribution 910 is displayed in the form of an interactive quantile-dot plot that may be shaped by the user in real time.

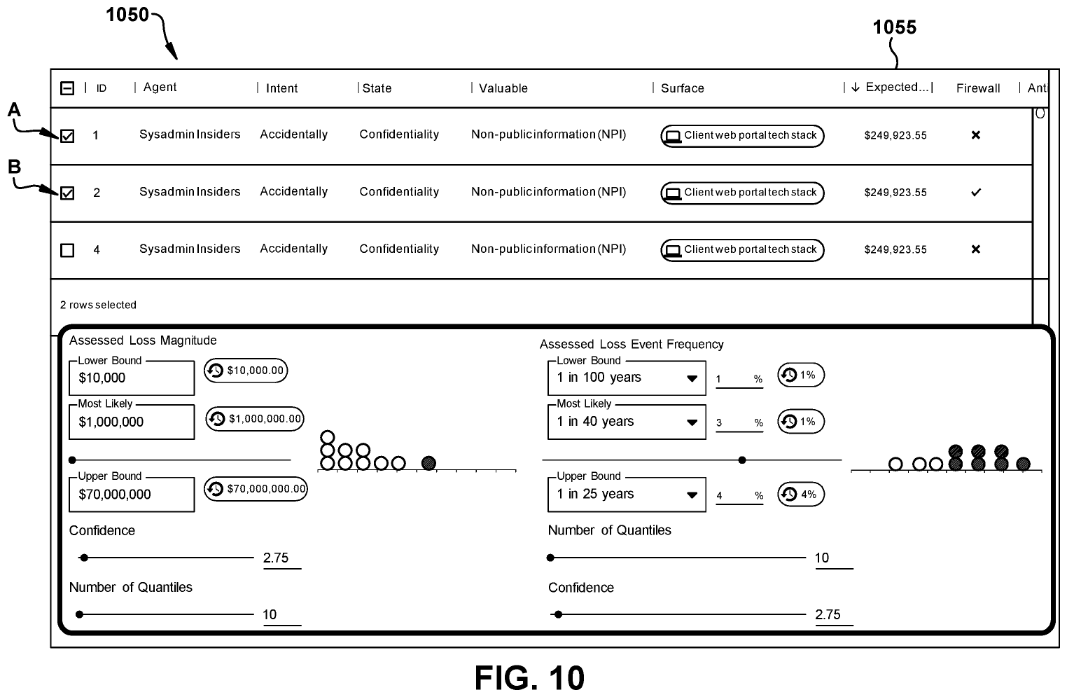

Turning to FIG. 10, an example scenario user-interface 1050 is shown that may allow the user to enter loss data (e.g., loss values and/or loss event frequency data) for multiple scenarios simultaneously (e.g., bulk estimation). For example, the user can select check boxes associated with scenarios A and B and be prompted to enter loss values and loss event frequency data for both scenarios. This is particularly beneficial for streamlining a risk assessment, for example, instead of having to click through one row or one page per scenario at a time. A filter 1055 may be used to prioritize the risk scenarios based on the expected loss value, for example, by filtering the values in a descending order. In some embodiments, the user can apply an “outside-in approach” by bulk estimating expected losses across multiple scenarios (e.g., to gain a high-level overview) to determine which scenarios should be remedied to maximize a return on cybersecurity risk control investment, e.g., by applying the Pareto principle).

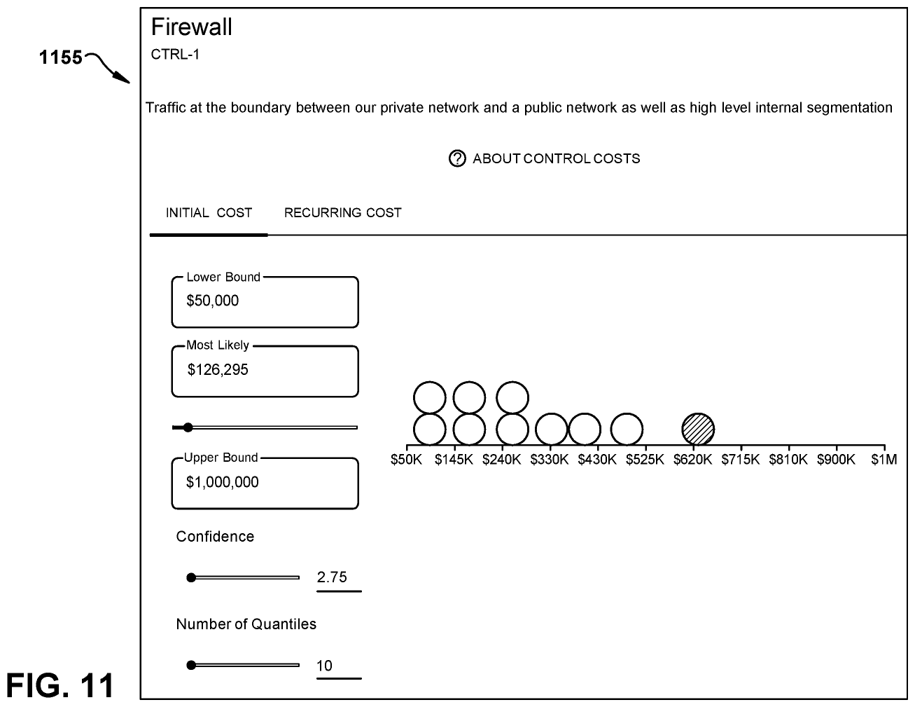

Turning to FIG. 11, an example controls user-interface 1155 is shown according to an embodiment. In general, the controls user-interface 255 is configured to receive inputs from the user concerning cost estimates (i.e., control cost values) for controls that may be implemented to mitigate risk. For instance, controls may take the form of an antivirus software, a firewall, data encryption, user-authentication, or a prospective data source (e.g., an expert estimate) to narrow a range. Control cost values represent the costs for acquiring, implementing, and/or maintaining the controls, and can take the form of initial costs and/or recurring costs. For instance, initial costs may include an initial capital outlay to acquire and/or implement the controls, and recurring control costs may include, for instance, subsequent annual, maintenance, or subscriptions fees or ongoing labor expenses. Other examples of control costs may include an expected loss of productivity and/or customers (e.g., due to a password policy that is too cumbersome), the cost to transfer, clean, process, and analyze data, or the cost to protect and/or acquire data from external data sources (e.g., the cost to acquire expert estimates. For purposes of the present disclosure, controls and control cost values may be referred to as “control data.”

As can be seen, the controls user-interface 1155 has several of the same features as the scenario user-interface 250, 700, 800 discussed above. For example, the user may enter control cost values as a range comprising a lower bound, an upper bound, and a most likely value to result in a distribution reflected in an interactive quantile dot plot that may be dynamically altered by the user. Moreover, the control cost values may similarly be derived from expert, industry, or internal data using any of the examples of knowledge or data elicitation discussed above. In some embodiments, the control cost values may be derived directly from vendor quotations (e.g., regarding IT security proposals) obtained by the user organization.

The resulting distribution displayed via the controls user-interface 1155 may be visually altered by the user in the same manner as described above and in previous figures (via the interactive quantile-dot plot), allowing the user to express their uncertainty concerning control cost estimates (by adjusting the control cost values and/or precision or confidence in real time). The distribution resulting from the cost controls data contributes to a more accurate depiction of the risk associated with the control cost estimates.

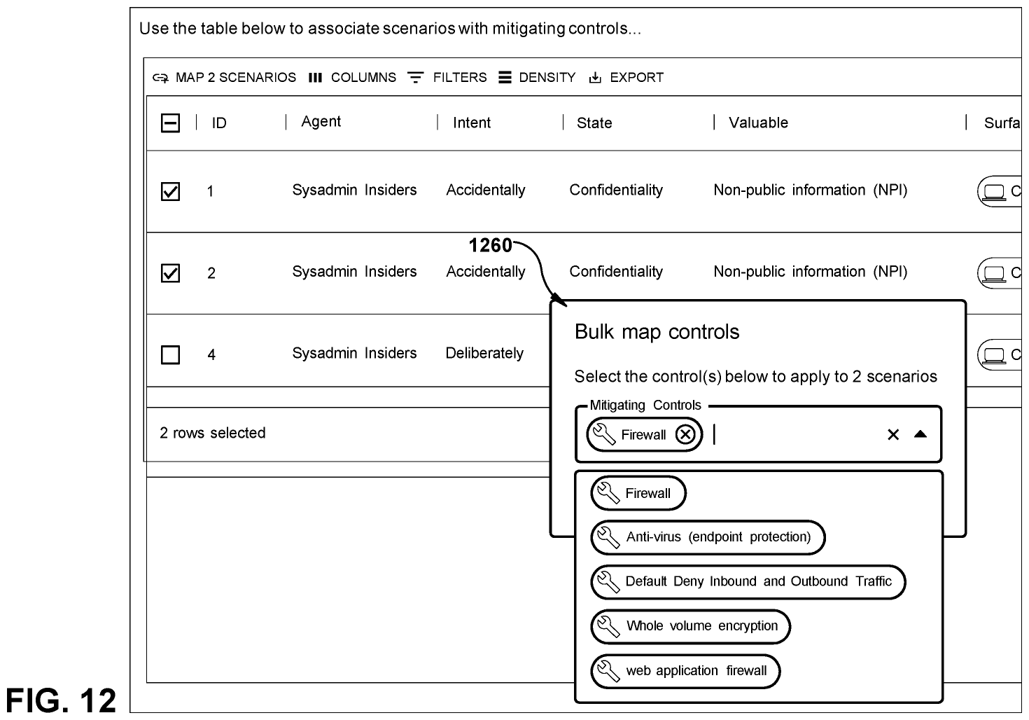

In FIG. 12, controls may be mapped to the risk-scenarios via the mapping component 220 and the mapping user-interface 260, 1260 as described herein. For example, the user may desire to map the control of “firewall” to a risk scenario involving “malware.” In addition, the user may map one or more controls (i.e., bulk control mapping) to one or more selected scenarios at the same time, thereby reducing assessment time and user error. For instance, the user may select multiple scenarios (via checkboxes as shown) and apply one or more controls to the listed scenarios, e.g., a firewall to multiple scenarios.

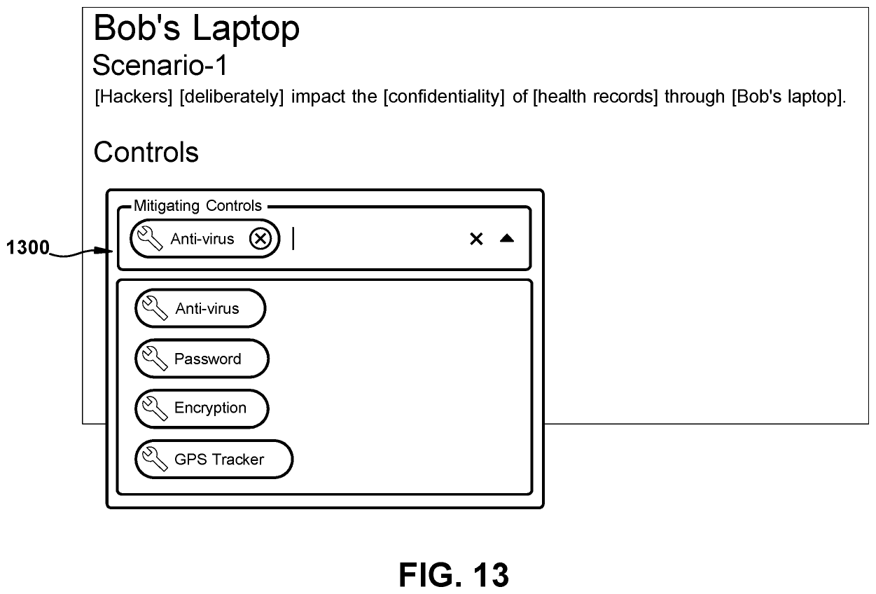

As shown in FIG. 13, the risk modeling component 120 may also recommend controls to the user in the form of a pop-up 1300 comprising a list of recommended controls (e.g., password, encryption, GPS tracker) based on scenario data received via the user interface. In the illustrated example, a list of recommended controls is determined based on the following scenario data: Agent=hackers; Intent=deliberately; State=confidentiality; Valuable=health records; and Surface=Bob's laptop. Based on this scenario data, the risk-modeling component 120 recommends the controls of a password, encryption, and GPS tracker.

To accomplish this recommendation function, the risk modeling component 120 generates recommended controls utilizing a Bayesian network comprising multiple tables, wherein each such table references another table. In such embodiments, the probability value of each recommended control will change based on information received by the risk-modeling component 120 (e.g., changes in scenario data, industry data, trends of the subject organization). For example, an organization that frequently utilizes encryption will see encryption jump to the top of the list more than an organization that routinely does not rely on encryption as a control.

Once the user has mapped controls to the scenario data, the user can assess the expected loss after implementation of the controls. For this purpose, the user may submit updated expected loss data to the scenario user-interface in the same manner as above (e.g., via the scenario user-interface). For this purpose, the user may elicit expert feedback, industry feedback, or internal feedback, for example, via any such example of knowledge elicitation described above. In addition, the user may update the expected loss across multiple scenarios at the same time, for example, as described above and shown in FIG. 10. In some embodiments, the scenario user-interface 250, 650, 1050 may allow the user to update the expected loss across multiple scenarios with a universal effect control option. For instance, to the extent one control is applicable to multiple risk scenarios (and achieves a similar loss reduction effect), the user can select check boxes associated with those risk scenarios and apply a uniform risk reduction to the selected scenarios. For instance, the user may find that implementing a firewall control may result in a 10-15% reduction in expected loss for multiple risk scenarios. This option is useful to avoid having to enter the updated expected loss value for each risk scenario (one at a time), thereby reducing the amount of time to perform a risk assessment.

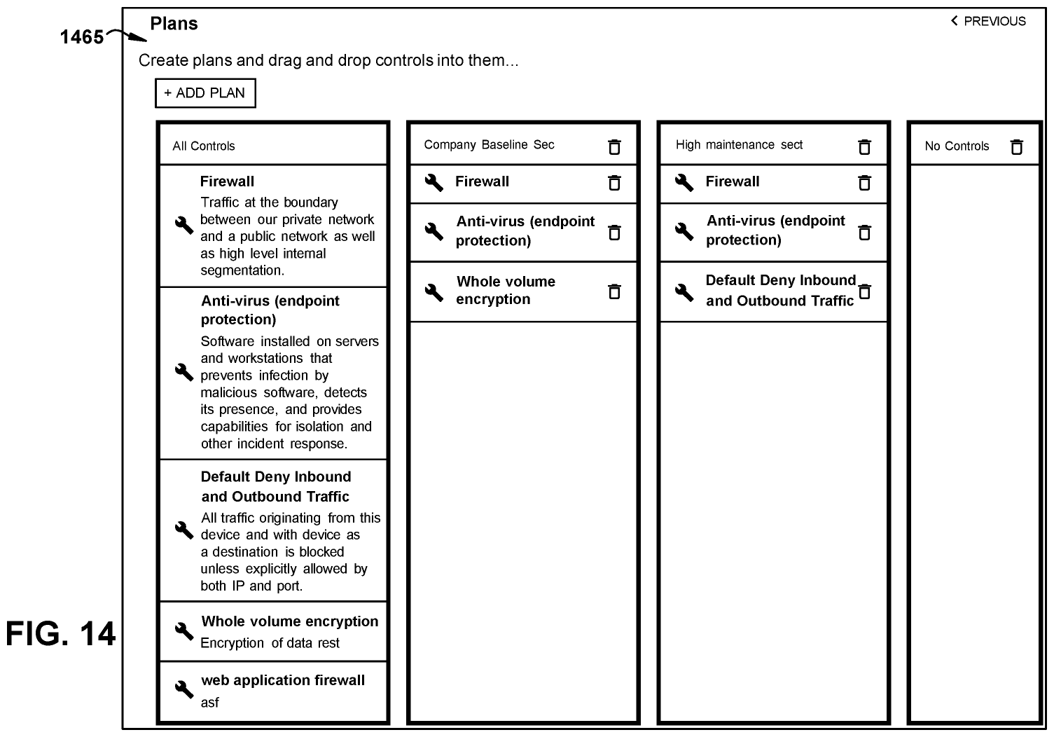

Referring to FIG. 14, an example of a plans-user interface 1465 is shown. The plans user-interface 265, 1465 as described herein groups controls for assessing the change in risk assuming grouped controls (i.e., plans) are implemented. This enables users to compare the relative value of control sets, e.g., a firewall and anti-virus software instead of controls in isolation e.g., just a firewall. Moreover, this allows users to model control scenarios that are more familiar to them since many users have no experience implementing controls in isolation and lack reliable intuition of their efficacy. Users can create as many control sets or groups (i.e., plans) as they desire. They may also choose to make separate plans for individual controls for ascertaining risk associated with individual controls.

In some embodiments, it is contemplated that the plans may be derived from vendor proposals. For example, a first plan may comprise a first vendor cost estimate for a firewall, and a second plan may comprise a second vendor cost estimate for the same firewall.

The user can perform a simulation by accessing the simulate user-interface 270 (FIG. 2) to run a simulation. In some embodiments, the user may be presented with an option to select a desired simulation, for example, the option to choose between a simple Monte Carlo simulation, a Markov Chain Monte Carlo simulation, and Bayesian networks.

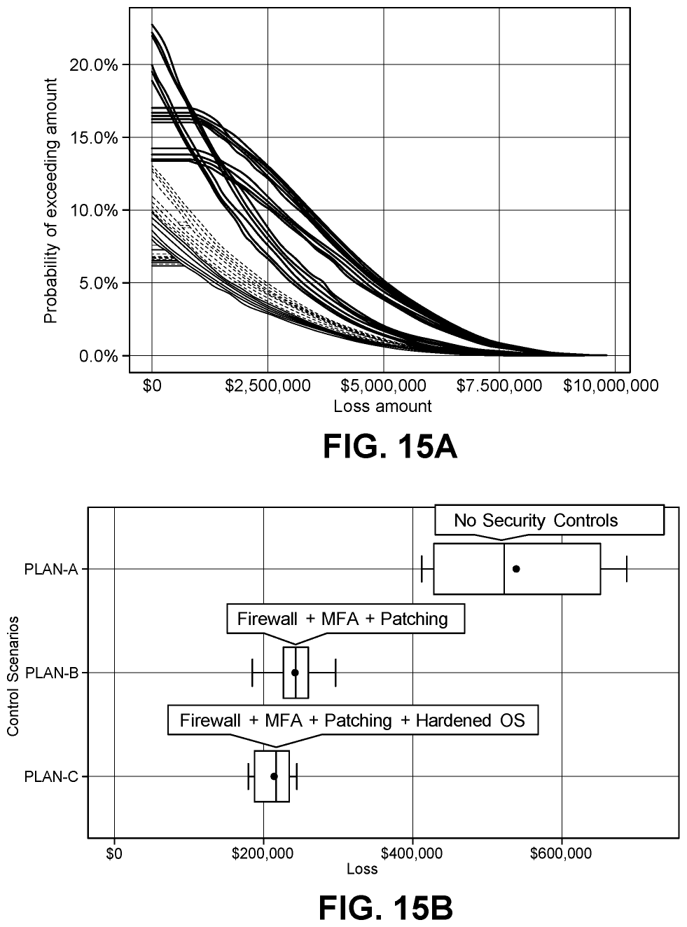

FIGS. 15A-17B demonstrate various forms of output displays or reporting different types of information. For example, the results of a simulation can be presented in various reports that convey information to a decision maker to make strategic investments concerning cybersecurity controls. For example, referring to FIGS. 15A-15B, the expected loss amount associated with various plans may be shown in relation to a scenario with no security controls, and relative to the probability of exceeding a loss amount (FIG. 15A) (i.e., a loss exceedance curve)-wherein respective plans are indicated with different colors or indicia and shown relative to a no security control scenario. Moreover, the expected loss amount may be shown on a map (FIG. 15B) (i.e., a box and whisker plot) plotting various plans against each other (and relative to a no control scenario).

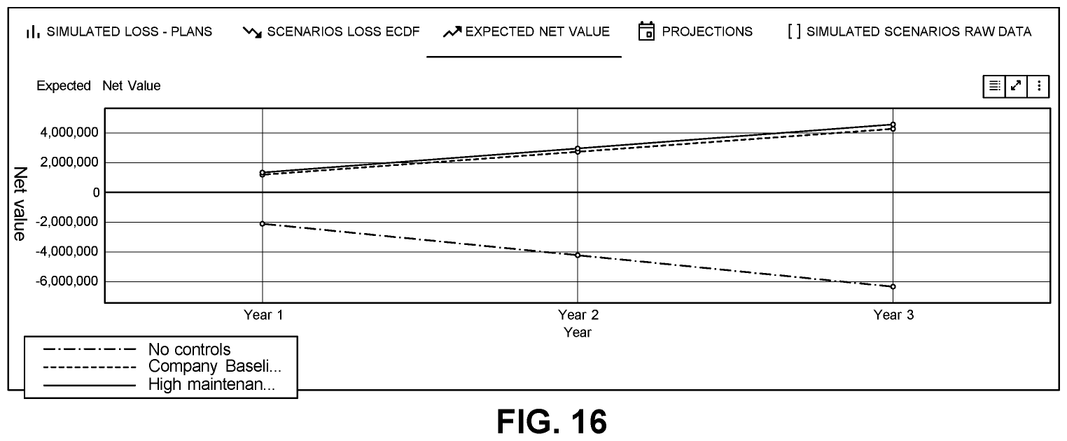

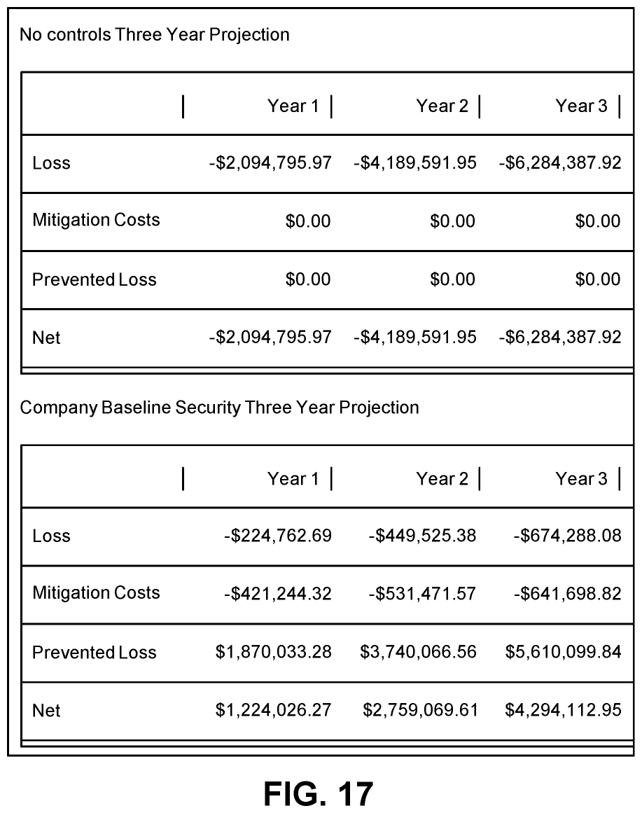

As shown in FIG. 16, the expected net value of various plans (relative to a no control scenario) may also be shown over a projected period of time, for example, while accounting for recurring control costs and/or changes in risk over time. In FIG. 17, the results (expected net value or loss) may be displayed in columns, each coinciding with a specific year, e.g., a three-year projection is shown. It is contemplated that a wide variety of displays are possible for displaying the results of a risk modeling assessment with the cybersecurity risk management system.

It is to be appreciated that the cybersecurity risk management system of the present disclosure is a living model, insofar as it can be maintained continuously (e.g., throughout a year) by a combination of user input, telemetry from external devices and industry data, and model maintenance features, for example a temporal risk functionality that expands ranges over time to reflect time as a risk of itself.

In this manner, the cybersecurity risk management system enables users to obtain snapshots from the living model (e.g., in-time reports that can be presented to executives and filed for auditors). Moreover, unlike non-quantitative or scoring-based risk platforms, the cybersecurity risk management system as described herein has the advantage of being quantitative by eliciting risk from and articulating risk to users (e.g., management) more effectively by using dollar amounts (e.g., instead of words or scores which can be interpreted different but between different people and even between the same person at a different time).

Further, the cybersecurity risk management system as described herein may have features that help reduce the risk of erroneous, inaccurate, or imprecise modeling due to human error, biases, and noise (e.g., via Bayesian networks). For example, the cybersecurity risk management system may continuously scan user input patterns for signs of cognitive compromise including mistakes, bias, noise, and logically unsound models.

In some embodiments, the results of a cybersecurity risk assessment may be transmitted from the cybersecurity risk management system to other operating systems (e.g., the organization's operating system), for example, to prioritize activities in vulnerability remediation, suspicious activity investigation (SIEM/SOC), risk-based authentication, risk-based access control, etc. It also is to be appreciated that the results of an earlier risk assessment (i.e., risk model) undertaken by the cybersecurity risk management system may be used to inform a future risk assessment. For example, the effectiveness of control information (e.g., reduction in expected loss) derived from one risk assessment may be used as data to inform a future risk assessment.

In some embodiments, the cybersecurity risk management system may be adapted to send notifications concerning one or more risk scenarios, for example, when one or more risk scenarios exceed set thresholds such as due to a control failure, or when an assessment has not been updated for many months, or when a model incongruity was observed.

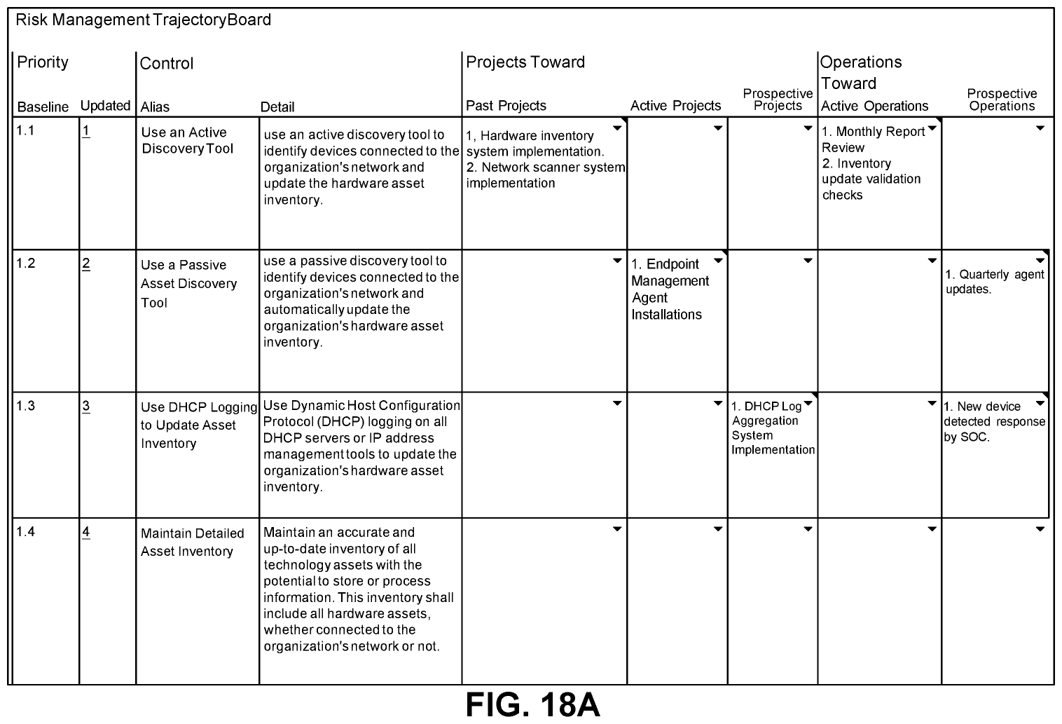

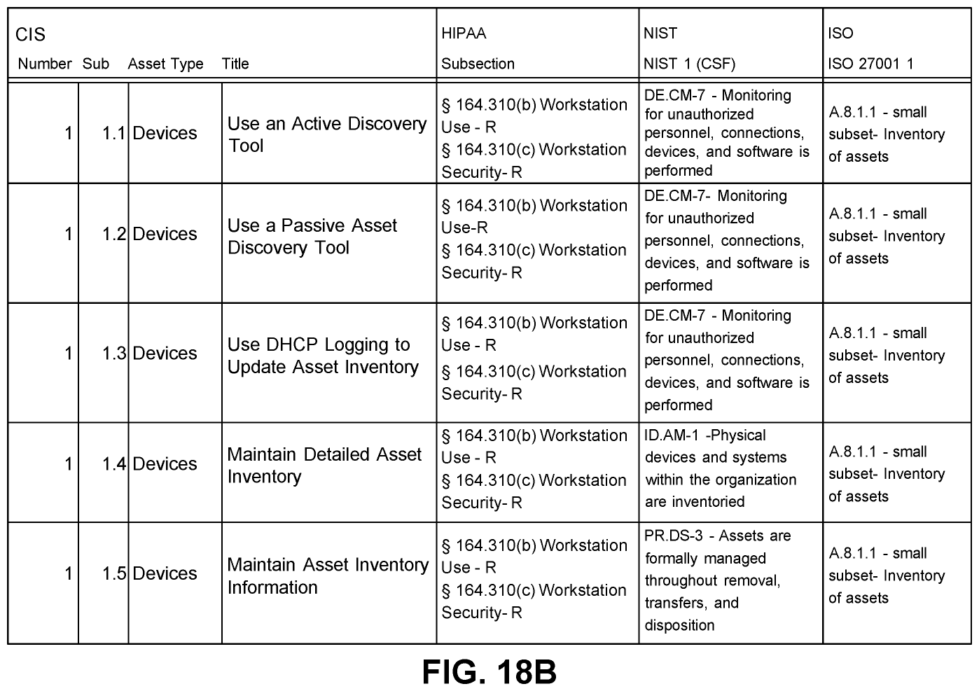

In some embodiments, the cybersecurity risk management system may include a risk management trajectory board (see FIG. 18A, 18B) that provides users a change-controlled list of their past, present, and prospective security efforts in the form of projects (discrete) and operations (continuous). This may embody a display that lists each control in a control framework of choice (Default is CIS-18) in one column, then past, present, and prospective projects in the next three columns followed by another three columns representing present and prospective operational duties. The projects and operations listed may be those that contribute to the respective controls in the first column. Finally, there may be a column indicating the priority of a respective control to the organization. In this manner, the risk management trajectory board helps the organization contextualize projects in scope of other projects the organization is undertaking.

In such embodiments, a user's first task may be to modify the priority suggested by the control framework provider then submit the new order of priority to the user's management for approval. This change control process is what formalizes management's expectations of what controls company resources should be spent on and in what order, starting at the top of the list. Changes to the priority, projects, or operations may be requested as a result of changes from regulators, risk assessments, systemic operational issues etc. But any proposed changes may require the indicated chain of management approval before resources can be pulled away from projects and operations. This forces management to consider which security efforts will be deprioritized as a result of the prospective changes.

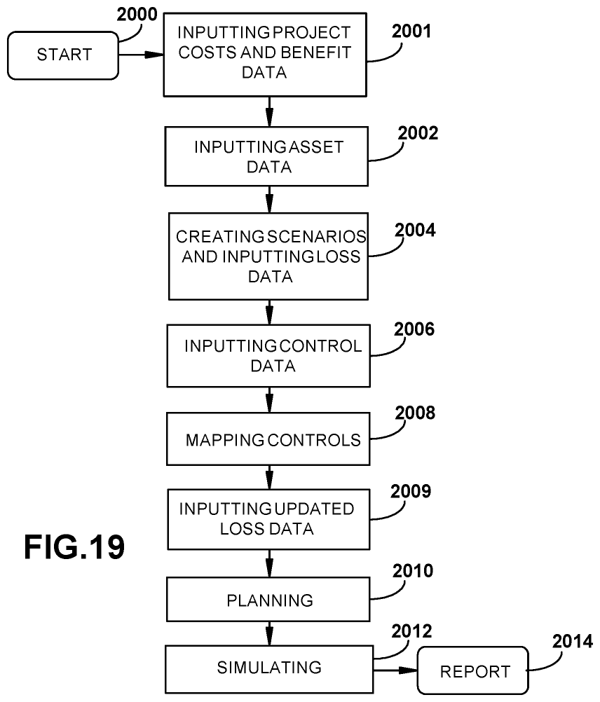

Referring to FIG. 19, an exemplary method of managing cybersecurity risk will now be described with reference to a flow chart. First, at step 2000, the method may include starting a cybersecurity risk analysis by receiving user information, including, but not limited to, the user's name and organization. In some embodiments, step 2000 may also include sending messages to other users (e.g., for granting access to the cybersecurity risk analysis). Next, at step 2001, the method may include inputting project cost and benefit data associated with information technology in scope of the risk assessment (regardless of the risks involved). For example, project costs may include information such as the price of the information technology, the cost of undertaking the risk assessment, and ongoing support costs. Benefits may include information such as benefit hours reduced by the information technology, increased marketing coverage, and expected error reduction.

Next, at step 2002, the method may include inputting asset data (e.g., via the assets user-interface) concerning any assets associated with cybersecurity risk scenarios modeled by the user, for example, servers, laptops, handhelds, and the like.

Next, at step 2004, the method may include inputting scenario data (e.g., via the scenario user interface), for example, any such example of scenario data described above (e.g., agent, intent, surface, valuable, and the like). In addition, at step 2004, the method may include inputting loss data (e.g., via the scenario user interface, for example, loss values and loss event frequency data assuming no controls or countermeasures). For example, step 2004 may include receiving loss data via the scenario component 210 (FIG. 2).

Next, at step 2006, the method may include inputting control data (e.g., via the control user interface), including controls and associated control cost values. For example, step 2006 may include receiving control cost values via the controls component 215 (FIG. 2). Next, at step 2008, the method may include mapping one or more controls (e.g., via the mapping user-interface) to scenario data. For example, step 2006 may include receiving user inputs of mapped controls via the mapping component 220 (FIG. 2).

At step 2009, the method may include inputting updated loss data in view of mapped controls. For example, this may include inputting updated expected loss values and/or loss event frequency data via the scenario user-interface.

At step 2010, the method may create plans of grouped controls (e.g., planning via the plans user-interface). Step 2010 may also include receiving inputs of proposed plans via the plans component 225 (FIG. 2).

At step 2012, the method includes performing simulations based on input data (e.g., loss data and updated loss data) to generate multiple possible expected loss outcomes (e.g., via the simulate component 230 (FIG. 2)). Step 2012 may include clicking a button to via the simulate user-interface 270 (FIG. 2). Lastly, at step 2014, the method may include generating reports indicating expected loss and/or gain via each plan relative to a no control cost scenario. In some embodiments, the method may include control implementation project tracking, and control maintenance operations tracking (e.g., via a risk management trajectory board).

The invention has been described with reference to the example embodiments described above. Modifications and alterations will occur to others upon a reading and understanding of this specification. Example embodiments incorporating one or more aspects of the invention are intended to include all such modifications and alterations insofar as they come within the scope of the appended claims and their equivalents.

What is claimed is:

1. A cybersecurity risk management user-interface comprising:
one or more input components for receiving input data associated with at least one risk scenario, wherein the user-interface:
receives the input data, said input data comprising a loss value, and
graphically displays the loss value as a first interactive probability distribution based on a first precision setting, wherein the first interactive probability distribution is visually responsive to changes in the loss value and/or the first precision setting in real time to visualize monetary risk.

2. The cybersecurity risk management user-interface of claim 1, wherein the user-interface graphically displays said changes in the form of a second interactive probability distribution.

3. The cybersecurity risk management user-interface of claim 1, wherein the user-interface subsequently receives updated input data associated with the at least one risk scenario, said updated input data comprising an updated loss value, and then graphically displays the updated loss value as a second interactive probability distribution based on one of the first precision setting or a second precision setting, wherein the second interactive probability distribution is visually responsive to changes in the updated loss value and/or in the first or second precision setting in real time to visualize updated monetary risk.

4. The cybersecurity risk management user-interface of claim 3, wherein the input data further comprises control data comprising a risk control and a control cost value, and wherein the user-interface graphically displays the control cost value as a third interactive probability distribution based on a control precision setting, wherein the third interactive probability distribution is visually responsive to changes in the control cost value and/or the control precision setting.

5. The cybersecurity risk management user-interface of claim 4, wherein the user-interface projects a first expected loss without the risk control relative to a second expected loss based on the risk control.

6. The cybersecurity risk management user-interface of claim 1, wherein the input data further comprises loss event frequency data, and wherein the user-interface graphically displays the loss event frequency data as a second interactive probability distribution based on a loss event frequency precision setting, wherein the second interactive probability distribution is visually responsive to changes in the loss event frequency data and/or the loss event frequency precision setting.

7. The cybersecurity risk management user-interface of claim 1, wherein the input data further comprises control data including a control cost value, and wherein the user-interface graphically displays the control cost value as a second interactive probability distribution based on a control precision setting, wherein the second interactive probability distribution is visually responsive to changes in the control cost value and/or the control precision setting.

8. The cybersecurity risk management user-interface of claim 1, wherein the user-interface comprises a precision slider input component operable to adjust the first precision setting in real time.

9. The cybersecurity risk management user-interface of claim 1, wherein the first interactive probability distribution is a quantile-dot plot.

10. The cybersecurity risk management user-interface of claim 1, wherein the user-interface comprises a quantile slider input component operable to adjust a number of quantiles visually displayed in the first interactive probability distribution in real time.

11. A cybersecurity risk management system comprising:
a risk-modeling component that:
receives scenario data, said scenario data comprising at least one of an agent, intent, state, valuable, and surface, and
recommends a risk mitigation control based on the scenario data.

12. The cybersecurity risk management system of claim 11, wherein the risk-modeling component utilizes a Bayesian network to recommend the risk mitigation control based on the scenario data.

13. The cybersecurity risk management system of claim 11, wherein the risk-modeling component is operatively connected to a domain knowledge component, said domain knowledge component being operable to provide a loss value associated with a risk scenario, said loss value derived from an expert estimate.

14. The cybersecurity risk management system of claim 11, wherein the risk-modeling component is operatively connected to an industry data component, said industry data component being operable to provide a loss value associated with a risk scenario, said loss value derived from a public data source.

15. The cybersecurity risk management system of claim 11, wherein the risk-modeling component is operatively connected to an internal data component, said internal data component being operable to provide the loss value associated with a risk scenario, said loss value derived from internal data of an operating system.

16. A method of managing cybersecurity risk comprising:
a. providing a cybersecurity risk management system comprising a risk-modeling component and a user-interface;
b. receiving scenario data and loss data concerning a cybersecurity risk scenario, wherein the user-interface visualizes the loss data in the form of a first interactive quantile-dot plot;
c. determining a first expected monetary loss;
d. receiving control data;
e. receiving updated loss data, wherein the user-interface visualizes the updated loss data in the form of a second interactive quantile-dot plot; and
f. determining, via the risk-modeling component, a second expected monetary loss based on the updated loss data.

17. The method of managing cybersecurity risk of claim 16, wherein the method further comprises a step of mapping the control data to the scenario data before the step of receiving the updated loss data, wherein the control data comprises a mitigation control and a control cost value, and wherein the scenario data comprises at least one of:
i. an agent;
ii. intent;
iii. state;
iv. valuable; and
v. surface.

18. The method of managing cybersecurity risk of claim 16, wherein the method further comprises receiving project cost and project benefit data, and determining the second expected monetary loss based on the project cost data, the project benefit data, and the updated loss data.
